(19) United States
(12) Patent Application Publication
(10) Pub. No.: US 2025/0215746 A1
(43) Pub. Date: Jul. 3, 2025

(54) BLIND CORD SPOOL STRUCTURE

(71) Applicant: SHIH-MIN HUNG, Dacun Township (TW)

(72) Inventor: SHIH-MIN HUNG, Dacun Township (TW)

(21) Appl. No.: 19/001,507

(22) Filed: Dec. 25, 2024

(30) Foreign Application Priority Data
Dec. 29, 2023 (CN) 2023236634678

(51) Int. Cl. E06B 9/322

(52) U.S. Cl. CPC E06B 9/322

(57) ABSTRACT

A blind cord spool structure has a cord spool. The cord spool includes a bottom case, force-receiving wheel, driven chainwheel, top case, two rotatable units, and two spool rollers. The bottom case is in long rectangular shape. The bottom case and the top case allow the force-receiving wheel, driven chainwheel, rotatable units and spool rollers to be fitted together. The force-receiving wheel meshes with the driven chainwheel through a plurality of planetary gears and interlocks with the spool rollers and rotatable units through a driven gear. The high speed reduction ratio of the planetary gears effectively reduces the required weight of a volute spiral spring and reduces the operation cost of the volute spiral spring. With the bottom case being in long rectangular shape, the force-receiving wheel, rotatable units and spool rollers can be collectively mounted on the same standard surface, allowing the cord spool to be structurally simple.

### FIELD

The present disclosure relates to blind structures, and more particularly to a blind cord spool structure that dispenses with a pull cord.

### BACKGROUND

Blinds are indoor tools of temporarily controlling the amount of light passing through window to avoid overexposure to sunlight and ensure a certain degree of privacy. In general, the height of every blind is usually controlled by pulling a pull cord. However, it is possible for the pull cord to become entangled or cause suffocation In an attempt to overcome the drawbacks, blinds that dispense with any pull cords are devised and equipped with reeling mechanisms for assisting with pulling and releasing the pull cords which penetrate slats. However, the frequent use of the reeling mechanisms in adjusting the target positions which the blinds can reach necessitates compressing and stretching a spring in every reeling mechanism repeatedly to rotate a gear. Furthermore, the restriction of blind positions inevitably requires the spring to overcome the restriction eventually. Owing to their repetitive, persistent compression and extension, the springs are predisposed to fatigue and damage, eventually leading to the instability of the reeling mechanisms. As a result, not only is the elasticity of the springs has to be augmented through their size, such as thickness and width, but position-limiting devices have to be mounted in place to provide friction for opposing the movement of the pull cords to protect the springs against fatigue otherwise arising from overuse of their elasticity, so as to reduce spring volume, cost, and the demand for spring elasticity.

U.S. Pat. No. 11,459,819B2 discloses a Venetian blind structure comprising: a frame; two string reels inserted in and supported by the frame, wherein each of the string reels is formed with a respective gear, wherein the gears of the string reels are in mesh with each other so that the string reels are rotatable in different directions; two spring reels inserted in and supported by the frame, wherein each of the spring reels is formed with a respective gear, wherein the gears of the spring reels are in mesh with each other so that the spring reels are rotatable in different directions; a leaf spring comprising two sections respectively wound on the spring reels so that one of the sections of the leaf spring gets longer and a remaining one of the sections of the leaf spring gets shorter when the spring reels are rotated; and a reducer located out of the frame so that the reducer is replaceable with another reducer, wherein the reducer comprises a leading wheel connected to one of the spring reels and a following wheel connected to one of the string reels, wherein the leading wheel is operatively connected to the following wheel, wherein a diameter of the leading wheel is smaller than a diameter of the following wheel so that the string reels rotate slower than the spring reels, and wherein none of the spring reels in engaged with any of the string reels without the reducer.

However, the aforesaid conventional spring reels and string reels lack any direct transmission relationship but require a leading wheel and a following wheel of a reducer in order to be indirectly driven. As a result, the conventional reducer is unable to achieve torque enhancement toward the spring reels. Thus, the leaf spring is not effective in reducing required length and volume and reducing structural cost despite increasingly high leaf spring prices, but requires a large transmission mechanism to the detriment of assembly space design.

The prior art still has room for improvement, and it is imperative to overcome the drawbacks of the prior art.

### SUMMARY

In view of the aforesaid drawbacks of the prior art, it is an objective of the disclosure to provide a blind cord spool structure.

To achieve the above and other objectives, the disclosure provides a blind cord spool structure having a cord spool. The cord spool comprises a bottom case, a force-receiving wheel, a driven chainwheel, two rotatable units, two spool rollers and a top case. The bottom case is in long rectangular shape, with a planetary gear seat centrally disposed at the bottom case, with a plurality of fitting posts disposed annularly on the periphery of the planetary gear seat, with a meshing space defined centrally at the planetary gear seat, with a plurality of fitting posts disposed annularly on the periphery of the planetary gear seat, with the fitting posts spaced apart from each other and fitted to a plurality of planetary gears, with two first rotating shafts and two second rotating shafts flanking the planetary gear seat, with a cord-releasing portion disposed at each of two ends of the bottom case. A hollow-core fitting hole having an inner annular toothed portion is disposed at the center of the force-receiving wheel. The force-receiving wheel is fitted to the planetary gear seat from outside through the hollow-core fitting hole, allowing the inner annular toothed portion to mesh with the planetary gears. A driven gear is disposed protrudingly at the center of one side of the driven chainwheel and disposed in the meshing space of the planetary gear seat to mesh with the planetary gears, allowing the driven chainwheel to rotatably rest on the force-receiving wheel. An interlocking chainwheel is disposed at the upper end of each of the two rotatable units, with a volute spiral spring reeled on each of the two rotatable units. The two rotatable units are fitted to the two first rotating shafts respectively to allow the interlocking chainwheels to mesh with the driven chainwheel, and one end of the volute spiral spring is fixed to two sides of the force-receiving wheel. The two spool rollers each have at least one reeling space for reeling a cord, with a driving chainwheel disposed at the upper end of each of the two spool rollers. The two spool rollers are fitted to the two second rotating shafts, allowing the driving chainwheel to mesh with the interlocking chainwheels of the rotatable units, allowing one end of the cord to be pulled out of the cord-releasing portions at the two ends of the bottom case. The top case is engaged with and fixed to the bottom case to further confine the force-receiving wheel, the two rotatable units and the two spool rollers to between the bottom case and the top case.

Preferably, each of the cord-releasing portions at the two ends of the bottom case has at least an axle and is fitted to a cord-guiding roller, allowing the cords to press against and pass the cord-guiding rollers before being pulled outward.

Preferably, each of the cord-releasing portions has three said axles, and each of the axles has one said cord-guiding roller.

Preferably, the planetary gear seat further has an upper lid, with a penetrating hole disposed at the center of the upper lid, with a plurality of fitting holes disposed on the periphery of the upper lid and corresponding in position to the fitting posts.

Preferably, a plurality of engaging upright plates are disposed on the periphery of the bottom case, whereas a plurality of engaging holes are disposed on the periphery of the top case, engaged with and fixed to the engaging upright plates.

Preferably, a first post is centrally disposed at the bottom side of the top case to abut against the center of the top end of the driven chainwheel, whereas two second posts and two third posts flank the first post, the two second posts abutting against centers of top ends of the interlocking chainwheels of the two rotatable units respectively, the two third posts being fitted to the two second rotating shafts of the bottom case respectively, allowing the driven chainwheel, rotatable units and spool rollers to be axially positioned in place. Compared with the prior art, the present invention has two advantages as follows:

First, owing to the coordination and linkage of the planetary gears and the force-receiving wheel, the high speed reduction ratio of the planetary gears effectively reduces the required weight of the volute spiral spring, greatly reduces the length and volume of the volute spiral spring, is conducive to the reduction of the operating cost of the volute spiral spring, facilitates the selection and installation of a blind, and enhances the applicability of the blind cord spool structure of the disclosure.

Second, since the bottom case of the cord spool is in long rectangular shape, the force-receiving wheel, rotatable unit and spool rollers can be collectively mounted on the same standard surface to render the cord spool structurally simple, greatly reduce the required height and width of the cord spool, enhance the applicability of the installation of the cord spool, effectively reduce the required volume of the head rail of the blind, reduce structural cost, enable the cord spool to better compete for market share, and encourage blind manufacturers to procure the blind cord spool structure of the disclosure.

### BRIEF DESCRIPTION OF THE DRAWINGS

FIG. 1 is a perspective view of a blind cord spool structure of the disclosure.

FIG. 2 is an exploded view of the blind cord spool structure of the disclosure.

FIG. 3 is a cross-sectional view of the blind cord spool structure of the disclosure.

FIG. 4 is a cross-sectional view of the blind cord spool structure taken along line A-A of FIG. 3.

FIG. 5 is a cross-sectional view of the blind cord spool structure taken along line B-B of FIG. 3.

FIG. 6 is an exploded view of the blind cord spool structure in use according to the disclosure.

FIG. 7 is a schematic view of the blind cord spool structure in use according to the disclosure.

FIG. 8 is a cross-sectional view taken along line A-A of FIG. 3, showing how a cord spool works in order to lower and unfold a blind body according to the disclosure.

FIG. 9 is a cross-sectional view taken along line B-B of FIG. 3, showing how the cord spool works in order to lower and unfold the blind body according to the disclosure.

FIG. 10 is a cross-sectional view of the blind cord spool structure according to another embodiment of the disclosure.

FIG. 11 is a cross-sectional view of the blind cord spool structure taken along line A-A of FIG. 10 according to another embodiment of the disclosure.

FIG. 12 is a cross-sectional view of the blind cord spool structure taken along line B-B of FIG. 10 according to another embodiment of the disclosure.

### DETAILED DESCRIPTION

Objectives, features, and advantages of the disclosure are herein illustrated with specific embodiments, depicted with drawings, and described below.

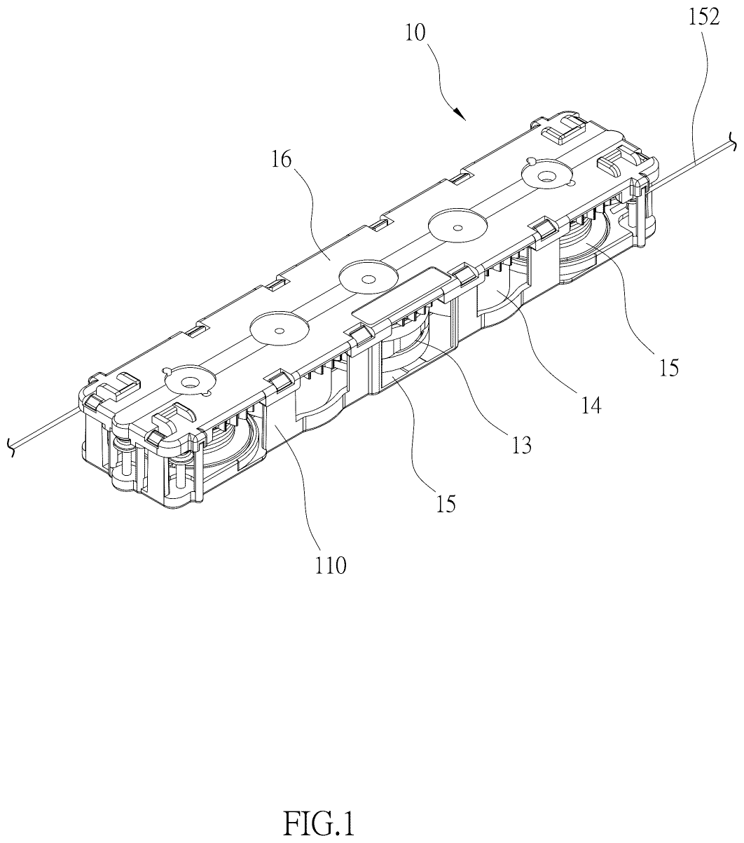

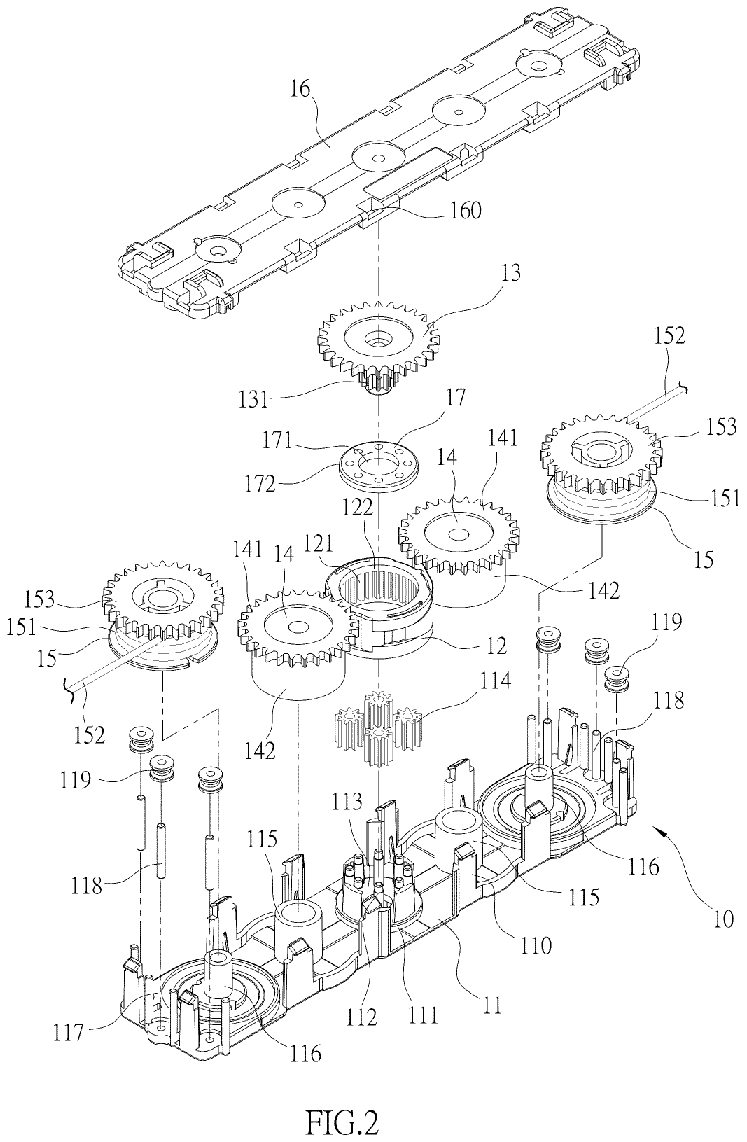

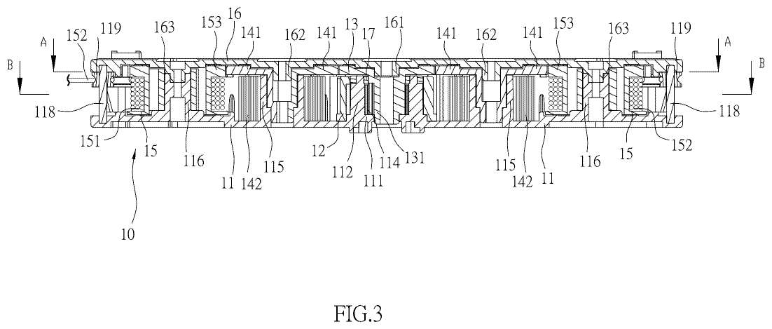

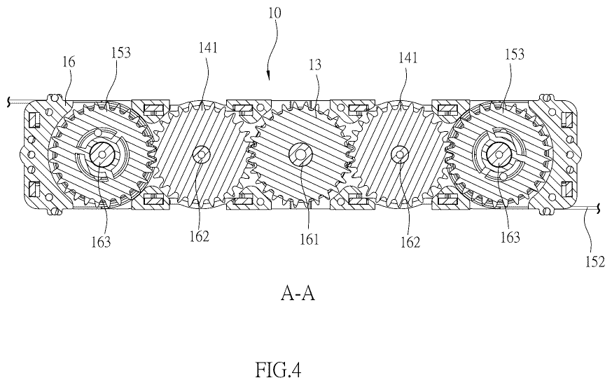

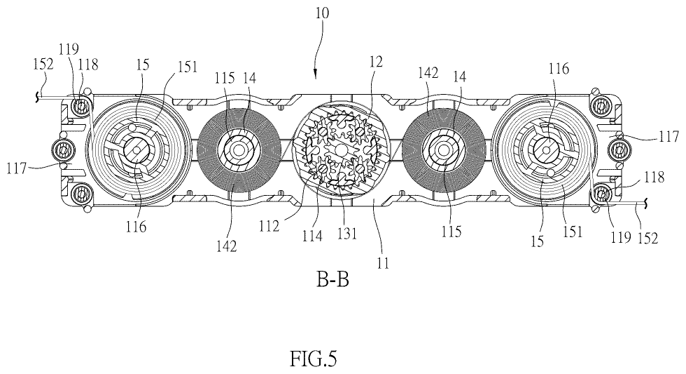

Referring to FIGS. 1 through 5, a blind cord spool structure has a cord spool 10. The cord spool 10 comprises a bottom case 11, a force-receiving wheel 12, a driven chainwheel 13, two rotatable units 14, two spool rollers 15 and a top case 16. The bottom case 11 is in long rectangular shape. A plurality of engaging upright plates 110 are disposed on the periphery of the bottom case 11. A planetary gear seat 111 is centrally disposed at the bottom case 11. A plurality of fitting posts 112 are disposed annularly on the periphery of the planetary gear seat 111. A meshing space 113 is defined centrally at the planetary gear seat 111. The fitting posts 112 are spaced apart from each other and fitted to a plurality of planetary gears 114. The planetary gear seat 111 further has an upper lid 17 above. A penetrating hole 171 in communication with the meshing space 113 is disposed at the center of the upper lid 17. A plurality of fitting holes 172 are disposed on the periphery of the upper lid 17 and correspond in position to the fitting posts 112. The fitting posts 112 are inserted into and fixed to the fitting holes 172. A first rotating shaft 115 and a second rotating shaft 116 flank the planetary gear seat 111 of the bottom case 11. A cord-releasing portion 117 is disposed at each of the two ends of the bottom case 11. Each of the cord-releasing portions 117 at least has an axle 118 and is fitted to a cord-guiding roller 119. Each of the cord-releasing portions 117 has three said axles 118, and the axles 118 each have the cord-guiding roller 119. A hollow-core fitting hole 122 having an inner annular toothed portion 121 is disposed at the center of the force-receiving wheel 12. The hollow-core fitting hole 122 enables the force-receiving wheel 12 to be fitted to the planetary gear seat 111 from outside, and thus the inner annular toothed portion 121 meshes with the planetary gears 114. A driven gear 131 is protrudingly disposed at the center of one side of the driven chainwheel 13. The driven gear 131 is inserted, through the penetrating hole 171 of the upper lid 17, into the meshing space 113 of the planetary gear seat 111 to mesh with the planetary gears 114, allowing the driven chainwheel 13 to rotatably rest on the force-receiving wheel 12. An interlocking chainwheel 141 is disposed at the upper end of each of the two rotatable units 14. A volute spiral spring 142 is reeled on each of the two rotatable units 14. The two rotatable units 14 are fitted to the two first rotating shafts 115 respectively, allowing the interlocking chainwheel 141 to mesh with the driven chainwheel 13. One end of each of the volute spiral springs 142 is fixed to two sides of the force-receiving wheel 12. Each of the two spool rollers 15 has at least one reeling space 151 for receiving a cord 152. A driving chainwheel 153 is disposed at the upper end of each of the two spool rollers 15. The two spool rollers 15 are fitted to the two second rotating shafts 116, allowing the driving chainwheels 153 to mesh with the interlocking chainwheels 141 of the rotatable units 14. After being pulled out of the spool rollers 15, the cords 152 press against and pass the cord-guiding rollers 119 and then are pulled out of the cord-releasing portions 117 at the two ends of the bottom case 11, respectively. A plurality of engaging holes 160 are disposed on the periphery of the top case 16. A first post 161 is centrally disposed at the bottom side of the top case 16. The first post 161 abuts against the center of the top end of the driven chainwheel 13. Two second posts 162 and two third posts 163 flank the first post 161. The two second posts 162 abut against the centers of the top ends of the interlocking chainwheels 141 of the two rotatable units 14. The two third posts 163 are fitted to the second rotating shafts 116 respectively to further axially position the driven chainwheel 13, rotatable units 14 and spool rollers 15 in place, allowing the force-receiving wheel 12, the two rotatable units 14 and the two spool rollers 15 to be confined to between the bottom case 11 and the top case 16. Finally, the engaging holes 160 are engaged with and fixed to the engaging upright plates 110 of the bottom case 11.

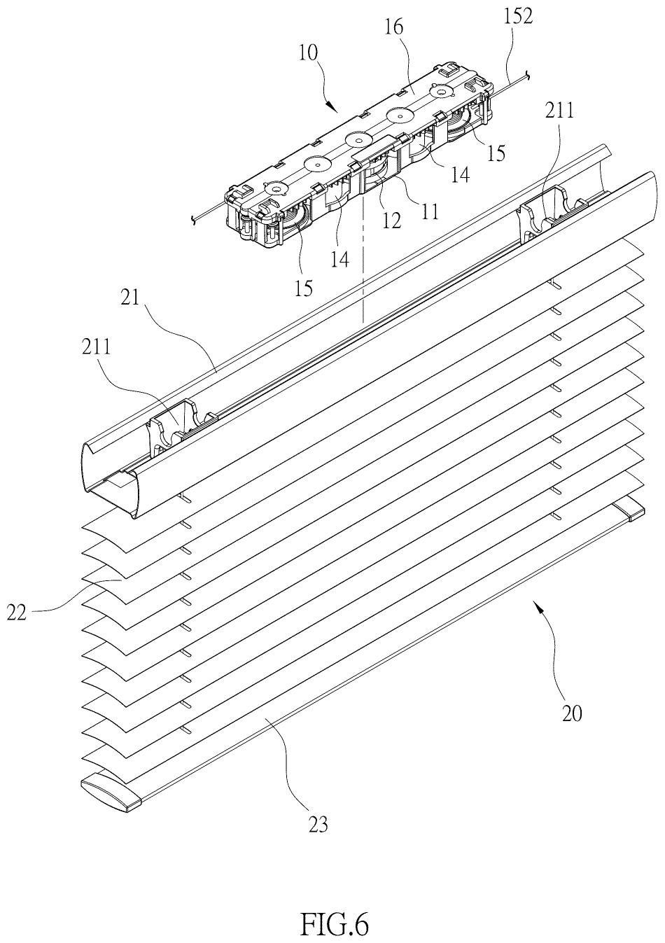

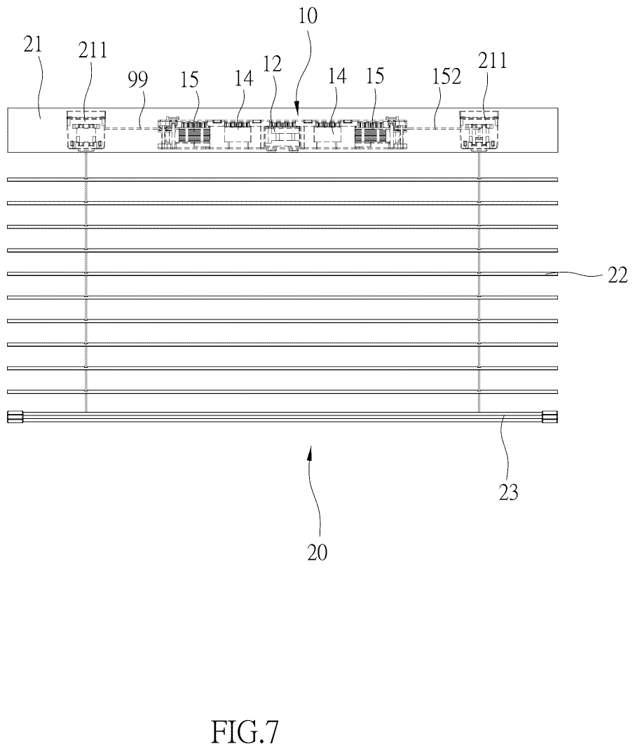

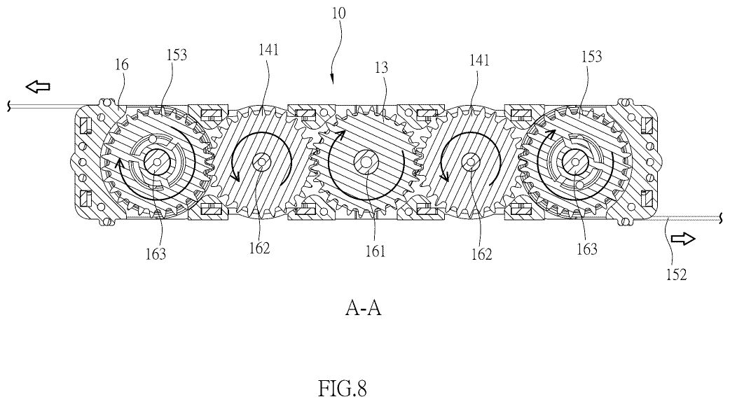

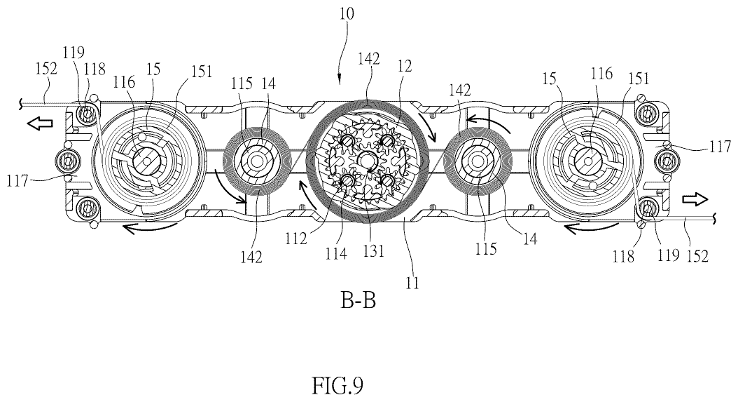

Referring to FIGS. 6 through 9, the cord spool 10 is centrally disposed in a head rail 21 of a blind 20. Two dampers 211 are disposed in the head rail 21 to flank the cord spool 10. A blind body 22 capable of unfolding and folding vertically is disposed below the head rail 21. A bottom rail 23 is disposed at the bottom end of the blind body 22. The two cords 152 are pulled out of the two cord-releasing portions 117 to pass through the dampers 211 and then move downward to protrude from the head rail 21. After that, the two cords 152 pass through the blind body 22 consecutively and then get connected to the bottom rail 23. In order to allow the blind body 22 to be pulled downward and unfolded, the two cords 152 are pulled out of the reeling space 151 of the two spool rollers 15 to drive the rotation of the two spool rollers 15; meanwhile, the two spool rollers 15 rotate because of the driving chainwheels 153 meshing with the interlocking chainwheels 141 of the two rotatable units 14. Thus, the two rotatable units 14 rotate and release the volute spiral springs 142; meanwhile, the two interlocking chainwheels 141 mesh with and interlock with the driven chainwheel 13 to cause the driven gear 131 to mesh with and interlock with the planetary gears 114 and drive the force-receiving wheel 12 rotating and reeling the two volute spiral springs 142. Thus, the planetary gears 114 augment the torque of the force-receiving wheel 12 to allow the force-receiving wheel 12 to reel in an effort-saving, smooth and easy manner until a taut state of the two volute spiral springs 142 is attained. Finally, the objective of pulling downward and positioning the blind body 22 is achieved through the energy of the volute spiral springs 142 of the cord spool 10 and the restraint from the bottom rail 23.

By contrast, in order for the blind body 22 to be pushed upward and folded through the bottom rail 23, the user slackens the two cords 152 and pushes the bottom rail 23 upward to thereby lessen the force required to keep the blind body 22 hanging; meanwhile, the elastic stress of the two volute spiral springs 142 is greater than the weight of the bottom rail 23 to allow it to begin rebounding, reeling and driving the force-receiving wheel 12 rotating reversely; meanwhile, the planetary gears 114 drive the rotation of the driven chainwheel 13 to cause the driven chainwheel 13 to mesh with and interlock with the two interlocking chainwheels 141 of the two rotatable units 14. Furthermore, the two interlocking chainwheels 141 of the two rotatable units 14 drive the rotation of the driving chainwheels 153 of the two spool rollers 15, allowing the two spool rollers 15 to rotate and synchronously reel the two cords 152. The planetary gears 114 have a high speed reduction ratio and thus increase the rotation speed of the two spool rollers 15, allowing the user to easily control the ascent and folding of the blind body 22 just by pushing the bottom rail 23 slightly. Moreover, the two volute spiral springs 142 restrain the bottom rail 23, and vice versa, allowing the blind body 22 to be positioned in place.

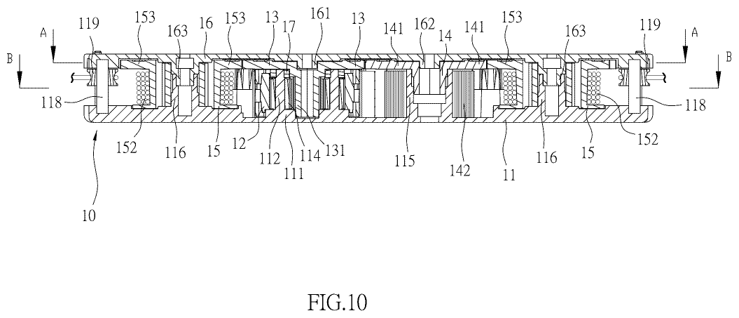

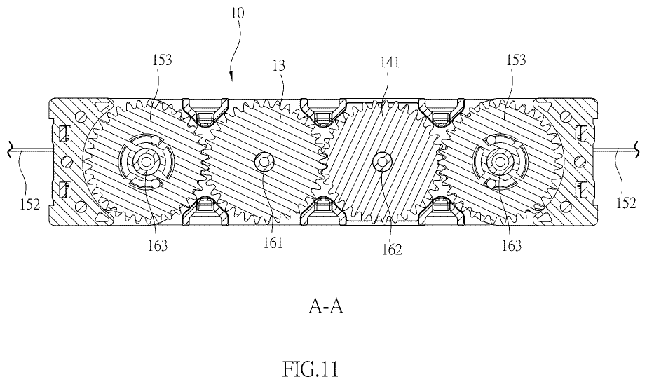

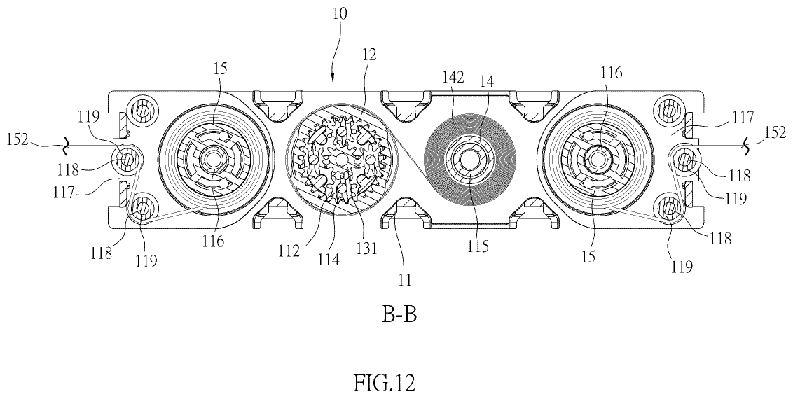

In another embodiment of the disclosure, one single rotatable unit 14 is provided. Referring to FIGS. 10 through 12, the cord spool 10 comprises a bottom case 11, a force-receiving wheel 12, a driven chainwheel 13, a rotatable unit 14, two spool rollers 15 and a top case 16. The bottom case 11 is in long rectangular shape. A plurality of engaging upright plates 110 are disposed at the periphery of the bottom case 11. A planetary gear seat 111 is centrally disposed at the bottom case 11. A plurality of fitting posts 112 are disposed annularly on the periphery of the planetary gear seat 111. The fitting posts 112 are spaced apart from each other and fitted to a plurality of planetary gears 114. The planetary gear seat 111 further has an upper lid 17 above; thus, the planetary gears 114 are confined to the fitting posts 112 respectively. A first rotating shaft 115 is disposed on one side of the planetary gear seat 111 of the bottom case 11. Two second rotating shafts 116 are disposed in the vicinity of the two ends of the bottom case 11 respectively. A cord-releasing portion 117 is disposed at each of the two ends of the bottom case 11. A hollow-core fitting hole having an inner annular toothed portion 121 is disposed at the center of the force-receiving wheel 12. The force-receiving wheel 12 is fitted to the planetary gear seat 111 from outside, allowing the inner annular toothed portion 121 to mesh with the planetary gears 114. A driven gear 131 is protrudingly disposed at the center of one side of the driven chainwheel 13. The driven gear 131 is inserted into the planetary gear seat 111 to mesh with the planetary gears 114, allowing the driven chainwheel 13 to rotatably rest on the force-receiving wheel 12. An interlocking chainwheel 141 is disposed at the upper end of the rotatable unit 14. A volute spiral spring 142 is reeled on the rotatable unit 14. Then, the rotatable unit 14 is fitted to the first rotating shafts 115, allowing the interlocking chainwheel 141 disposed at the upper end of the rotatable unit 14 to mesh with the driven chainwheel 13. The free end of the volute spiral spring 142 is fixed to the periphery of the force-receiving wheel 12. A cord 152 is reeled on each of the two spool rollers 15. A driving chainwheel 153 is disposed at the upper end of each of the two spool rollers 15. The two spool rollers 15 are fitted to the two second rotating shafts 116 respectively. The driving chainwheel 153 of one of the spool rollers 15 meshes with the driven chainwheel 13. The driving chainwheel 153 of the other spool roller 15 meshes with the interlocking chainwheel 141 of the rotatable unit 14. The free ends of the cords 152 are pulled out of the cord-releasing portions 117 at the two ends of the bottom case 11 respectively. A plurality of engaging holes 160 are disposed at the periphery of the top case 16. The top case 16 has a first post 161. The first post 161 abuts against the center of the top end of the driven chainwheel 13. Then, a second post 162 is disposed on one side of the first post 161. The second post 162 abuts against the center of the top end of the interlocking chainwheel 141 of the rotatable unit 14. Two third posts 163 are disposed in the vicinity of the two ends of the top case 16. The two third posts 163 are fitted to the two second rotating shafts 116 respectively to further allow the driven chainwheel 13, rotatable unit 14 and spool rollers 15 to be axially positioned in place, allowing the force-receiving wheel 12, the rotatable unit 14 and the two spool rollers 15 to be confined to between the bottom case 11 and the top case 16. Finally, the engaging holes 160 of the top case 16 are engaged with and fixed to the engaging upright plates 110 of the bottom case 11, accomplishing the cord spool 10.

Each of the cord-releasing portions 117 disposed at the two ends of the cord spool 10 has three cord-guiding rollers 119. The cord 152 on each of the two spool rollers 15 follows an S-shaped circuitous route to pass between two of the cord-guiding rollers 119. Then, the two cords 152 are pulled out of the cord-releasing portions 117 at two ends respectively. In particular, the cords 152 are passed through the centrally-located cord-guiding rollers 119 before being pulled outward in order for the cords 152 to be centrally aligned to increase the friction and stability of the cords 152. Furthermore, the two cord-guiding rollers 119 disperse the load of the cords 152, effectively reduce the wear and tear of the cords 152, further reduce the damage risk of the cords 152, and extend the service life of the blind cord spool structure of the disclosure.

The blind cord spool structure in the aforesaid embodiments of the disclosure has two advantages as follows:

First, owing to the coordination and linkage of the planetary gears 114 and the force-receiving wheel 12, the high speed reduction ratio of the planetary gears 114 effectively reduces the required weight of the volute spiral spring 142, greatly reduces the length and volume of the volute spiral spring 142, is conducive to the reduction of the operating cost of the volute spiral spring 142, facilitates the selection and installation of a blind, and enhances the applicability of the blind cord spool structure of the disclosure.

Second, since the bottom case 11 of the cord spool 10 is in long rectangular shape, the force-receiving wheel 12, rotatable unit 14 and spool rollers 15 can be collectively mounted on the same standard surface to render the cord spool 10 structurally simple, greatly reduce the required height and width of the cord spool 10, enhance the applicability of the installation of the cord spool 10, effectively reduce the required volume of the head rail 21 of the blind 20, reduce structural cost, enable the cord spool 10 to better compete for market share, and encourage blind manufacturers to procure the blind cord spool structure of the disclosure.

Therefore, the present invention not only embodies radical innovation and improvements on prior art but also exhibits high industrial applicability, inventiveness, and novelty.

The disclosure is disclosed above by a preferred embodiment, but the preferred embodiment is not restrictive of the scope of implementation of the disclosure. All equivalent changes and modifications made to the preferred embodiment according to the claims of the disclosure shall be deemed falling within the scope of the claims of the disclosure.

What is claimed is:

1. A blind cord spool structure, having a cord spool, the cord spool comprising:
a bottom case being in long rectangular shape, with a planetary gear seat centrally disposed at the bottom case, with a meshing space defined centrally at the planetary gear seat, with a plurality of fitting posts disposed annularly on a periphery of the planetary gear seat, with the fitting posts spaced apart from each other and fitted to a plurality of planetary gears, with two first rotating shafts and two second rotating shafts flanking the planetary gear seat, with a cord-releasing portion disposed at each of two ends of the bottom case, wherein a hollow-core fitting hole having an inner annular toothed portion is disposed at a center of the force-receiving wheel;
a force-receiving wheel fitted to the planetary gear seat from outside through the hollow-core fitting hole, allowing the inner annular toothed portion to mesh with the planetary gears;
a driven chainwheel, with a driven gear disposed protrudingly at a center of a side of the driven chainwheel and disposed in the meshing space of the planetary gear seat to mesh with the planetary gears, allowing the driven chainwheel to rotatably rest on the force-receiving wheel;
two rotatable units, with an interlocking chainwheel disposed at an upper end of each of the two rotatable units, with a volute spiral spring reeled on each of the two rotatable units, wherein the two rotatable units are fitted to the two first rotating shafts respectively to allow the interlocking chainwheels to mesh with the driven chainwheel, and an end of the volute spiral spring is fixed to two sides of the force-receiving wheel;
two spool rollers each having at least one reeling space for reeling a cord, with a driving chainwheel disposed at an upper end of each of the two spool rollers, wherein the two spool rollers are fitted to the two second rotating shafts, allowing the driving chainwheel to mesh with the interlocking chainwheels of the rotatable units, allowing an end of the cord to be pulled out of the cord-releasing portions at the two ends of the bottom case; and
a top case engaged with and fixed to the bottom case to further confine the force-receiving wheel, the two rotatable units and the two spool rollers to between the bottom case and the top case.

2. The blind cord spool structure of claim 1, wherein each of the cord-releasing portions at the two ends of the bottom case has at least an axle and is fitted to a cord-guiding roller, allowing the cords to press against and pass the cord-guiding rollers before being pulled outward.

3. The blind cord spool structure of claim 2, wherein each of the cord-releasing portions has three said axles, and each of the axles has one said cord-guiding roller.

4. The blind cord spool structure of claim 1, wherein the planetary gear seat further has an upper lid, with a penetrating hole disposed at a center of the upper lid, with a plurality of fitting holes disposed on a periphery of the upper lid and corresponding in position to the fitting posts.

5. The blind cord spool structure of claim 1, wherein a plurality of engaging upright plates are disposed on a periphery of the bottom case, whereas a plurality of engaging holes are disposed on a periphery of the top case, engaged with and fixed to the engaging upright plates.

6. The blind cord spool structure of claim 1, wherein a first post is centrally disposed at a bottom side of the top case to abut against a center of a top end of the driven chainwheel, whereas two second posts and two third posts flank the first post, the two second posts abutting against centers of top ends of the interlocking chainwheels of the two rotatable units respectively, the two third posts being fitted to the two second rotating shafts of the bottom case respectively, allowing the driven chainwheel, rotatable units and spool rollers to be axially positioned in place.

7. A blind cord spool structure, having a cord spool, the cord spool comprising:
a bottom case being in long rectangular shape, with a planetary gear seat centrally disposed at the bottom case, with a plurality of fitting posts disposed annularly on a periphery of the planetary gear seat and spaced apart from each other to be fitted to a plurality of planetary gears, with a first rotating shaft disposed on a side of the planetary gear seat, with two second rotating shafts disposed in vicinity of two ends of the bottom case, with a cord-releasing portion disposed at each of the two ends of the bottom case;
a force-receiving wheel fitted to the planetary gear seat from outside, wherein a hollow-core fitting hole having an inner annular toothed portion is disposed at a center of the force-receiving wheel, allowing the inner annular toothed portion to mesh with the planetary gears;
a driven chainwheel, with a driven gear disposed protrudingly at a center of a side of the driven chainwheel and positioned in the planetary gear seat to mesh with the planetary gears, allowing the driven chainwheel to rotatably rest on the force-receiving wheel;
a rotatable unit, with an interlocking chainwheel disposed at an upper end of the rotatable unit, with a volute spiral spring reeled on the rotatable unit, with the rotatable unit fitted to the first rotating shaft, allowing the interlocking chainwheel at the upper end of the rotatable unit to mesh with the driven chainwheel, allowing a free end of the volute spiral spring to be fixed to a periphery of the force-receiving wheel;
two spool rollers for reeling a cord each and being fitted to the two second rotating shafts respectively, with a driving chainwheel disposed at an upper end of each of the two spool rollers, wherein the driving chainwheel of one of the spool rollers meshes with the driven chainwheel, and the driving chainwheel of the other spool roller meshes with the interlocking chainwheel of the rotatable unit, allowing free ends of the cords to be pulled out of the cord-releasing portions at the two ends of the bottom case respectively; and
a top case engaged with and fixed to the bottom case to further confine the force-receiving wheel, the rotatable unit and the two spool rollers to between the bottom case and the top case.

8. The blind cord spool structure of claim 7, wherein each of the cord-releasing portions at the two ends of the bottom case has three axles, and each of the axles has a cord-guiding roller, allowing the cords to press against the cord-guiding rollers before being pulled outward.

9. The blind cord spool structure of claim 7, wherein the planetary gear seat further has an upper lid.

10. The blind cord spool structure of claim 7, wherein a plurality of engaging upright plates are disposed on a periphery of the bottom case, whereas a plurality of engaging holes are disposed on a periphery of the top case, engaged with and fixed to the engaging upright plates.

11. The blind cord spool structure of claim 7, wherein a first post is disposed at the top case and abuts against a center of a top end of the driven chainwheel, with a second post disposed on a side of the first post and abutting against a center of a top end of the interlocking chainwheel of the rotatable unit, with two third posts disposed in vicinity of two ends of the top case and fitted to the two second rotating shafts respectively, allowing the driven chainwheel, rotatable unit and spool rollers to be axially positioned in place.
